(19) United States
(12) Patent Application Publication
(10) Pub. No.: US 2026/0015472 A1
(43) Pub. Date: Jan. 15, 2026

(54) BIAXIALLY-ORIENTED BIODEGRADABLE FILM

(71) Applicant: Danimer IPCo, LLC, Bainbridge, GA (US)

(72) Inventors: Jerri DiRenzo, Wilmington, DE (US); Adam Johnson, Bainbridge, GA (US); Satyabrata Samanta, Bainbridge, GA (US); Laura Emery, Kaukauna, WI (US); Brad Dewayne Rodgers, Frisco, TX (US)

(73) Assignee: Danimer IPCo, LLC, Bainbridge, GA (US)

(21) Appl. No.: 18/994,204

(22) PCT Filed: Jul. 28, 2023
(86) PCT No.: PCT/US23/71248

§ 371 Date: Jan. 14, 2025

Related U.S. Application Data
(60) Provisional application No. 63/369,997, filed on Aug. 1, 2022.

(51) Int. Cl. C08J 5/12; B29D 7/01; B29K 67/00; B32B 27/08; B32B 27/36; C08L 67/04; C09J 5/06; C09J 7/35

(52) U.S. Cl. CPC C08J 5/128; B29D 7/01; B32B 27/08; B32B 27/36; C08L 67/04; C09J 5/06; C09J 7/35; B29K 2067/04; B29K 2995/0053; B29K 2995/006; B32B 2250/03; B32B 2250/244; B32B 2307/518; B32B 2307/7163; C08J 2367/04; C08J 2467/04; C08L 2203/162; C08L 2205/025

(57) ABSTRACT

A biaxially-oriented industrial or home compostable film web having at least 3 co-extruded layers selected from:
a skin film layer, a sealant film layer, and a combination of a sealant film layer and a skin film layer, wherein each of the sealant film layer and skin film layer includes a blend of from 0 to about 80 wt. % polyhydroxyalkanoate (PHA) and from about 20 to about 100 weight percent polylactic acid (PLA), and, optionally, minor amounts of other biopolymers, other polymers, nucleating agents, chain extenders, fatty amides, and fillers; and
a core film layer including a blend of from about 30 to about 80 wt. % polyhydroxalkanoate (PHA), from about 20 to about 40 wt. % polylactic acid (PLA), and, optionally, minor amounts of other biopolymers, other polymers, nucleating agents, chain extenders, fatty amides, and fillers.

### RELATED APPLICATION

This application is a continuation-in-part of provisional application Ser. No. 63/369,997, filed Aug. 1, 2022, now pending.

### TECHNICAL FIELD

The disclosure is directed to biodegradable films and in particular to methods for improving the dimensional stability of poly (hydroxyalkanoate)-based polymer films.

### BACKGROUND AND SUMMARY

Polymeric films are used for a variety of flexible packaging applications, including food packaging. The polymeric films are typically used in a bag making and heat-sealing process that is widely used for flexible packaging. The stability of the polymeric films is critical for maintaining product quality and preventing food quality deterioration during storage. The bag-making and heat-sealing processes are generally carried out at high temperatures. Semicrystalline polymeric films tend to shrink as they cool down from elevated temperatures. The degree of shrinkage largely depends on the composition of the film materials and processing conditions used to produce the film. Semi-crystalline materials shrink more than amorphous materials. The dimensional instability or shrinkage of the film when cooled from an elevated temperature plays a significant role in the overall quality of the finished product. Significant shrinkage during or after the bag making or heat-seal process can contribute to some imperfections in the finished product including leakages, risks of pinhole formation, and breakages in the sealing area.

Conventional polymeric films are typically not industrial or home compostable and thus contribute to environmental waste that must be disposed of. Biodegradable poly (hydroxyalkanoate)-based polymer films can also shrink when cooled to room temperature from an elevated temperature. The shrinkage properties of poly (hydroxyalkanoate)-based films create significant issues during the coating, metallization, lamination, printing, bag making, and sealing processes using the films. A conventional blown film process produces a poly (hydroxyalkanoate)-based polymer film with 45% to 50% shrinkage measured in the machine direction (MD) at 110° C. The temperature selected for shrinkage measurements is the temperature used for most of the film's post-processing pieces of equipment. The shrinkage value for the poly (hydroxyalkanoate)-based polymer films is significantly higher compared to the industry standard of less than 5% for other polymer films. Accordingly, what is needed is an improved process for making home compostable poly (hydroxyalkanoate)-based polymer films that provides films having a significantly lower shrinkage when used for packaging applications.

Oriented film is produced from plastic granules that are extruded and stretched by applying mono- or biaxial-orientation. The film can be oriented in the machine direction (MD) only, the transverse direction (TD) only, the MD and TD simultaneously, or the MD and TD sequentially. Sequential orientation (i.e., orientation in the MD, followed by orientation in the TD) is the most common method for producing biaxially-oriented film commercially. A typical biaxial-orientation process may include one or more of the following steps in the order presented:
1. A relatively thick sheet of plastic is cast from a slot die and rapidly cooled on a chill roll.
2. The cast sheet of film is stretched in the machine direction using heated rollers (to increase the temperature of the plastic above its glass transition temperature (Tg). The rollers consists of a series of nips that rotate at speeds progressively faster than each previous one.
3. The machine direction orientation (MDO) sheet of film is stretched in the transverse direction, by grasping each edge of the film with clips rotating on a continuous chain. As the clips pull the sheet forward, the track carrying the clips diverges to pull the plastic in the transverse direction.
4. The clips continue to carry the now relatively thin film (under uniform MD and TD tension) through a warm oven to anneal the plastic film.
5. After annealing, any required surface treatment is applied to the film. The thick edges of the film held by the clips gripping the sides thereof are trimmed off, and the film is rewound.
   Oriented films can acquire a wide variety of advantageous properties due to a change in the morphology of the molecular structure of the film as a result of the orientation process. Examples of such advantageous properties include optimal physical properties (e.g., stiffness and tear strength), good optical characteristics (e.g., transparency or gloss), and enhanced barrier properties. In comparison to other packaging materials, oriented films are lightweight and energy-efficient to produce.

The primary materials for biaxially-oriented films are polypropylene, polyester, and polyamide. Polyethylene and polylactic acid are also biaxially-oriented in commercial processes and used in commercial packaging applications. With the exception of polylactic acid, the conventional biaxially-oriented films are made from petroleum-based materials that are not biodegradable. In view of the foregoing, what is needed is an industrial or home-compostable biaxially-oriented film for use as print films and barrier films that can be converted into packaging structures that meet the performance demands and the required end-use certifications of a variety of packaging applications.

In view of the foregoing, there is provided an industrial and/or home-compostable biaxially oriented composite film that may be produced using the materials and methods described herein.

In one embodiment of the disclosure there is provided a biaxially-oriented industrial or home compostable film web that contains at least 3 co-extruded layers selected from: a skin film layer, a sealant film layer, and a core layer, wherein each of the sealant film layer and the skin film layer includes a blend of from 0 to about 80 wt. % polyhydroxyalkanoate (PHA) and from about 20 to about 100 weight percent polylactic acid (PLA), and, optionally, minor amounts of other biopolymers, other polymers, nucleating agents, chain extenders, fatty amides, and fillers; and a core film layer containing a blend of from about 30 to about 80 wt. % polyhydroxalkanoate (PHA), from about 20 to about 40 wt. % polylactic acid (PLA), and, optionally, minor amounts of other biopolymers, other polymers, nucleating agents, chain extenders, fatty amides, and fillers. The core film layer is disposed between a combination of the skin film layer and the sealant film layer, is disposed between two sealant film layers, or is disposed between two skin film layers, wherein each of the sealant film layer and the skin film layer contains the same or different amounts of PHA, PLA, and other biopolymers, other polymers, nucleating agents, chain extenders, fatty amides, and fillers.

In another embodiment there is provided a method for improving the dimensional stability of a biaxially-oriented industrial or home compostable film web that contains at least three co-extruded layers. The method includes extruding a composite poly (hydroxyalkanoate)-based polymer film; and annealing the composite poly (hydroxyalkanoate) polymer film at a temperature ranging from about 110° C. to about 130° C. during a biaxial orientation process.

In some embodiments, the biaxially-oriented industrial or home compostable film web includes: at least two sealant film layers wherein the at least two sealant film layers comprise a blend of from about 0 to about 80 wt. % polyhydroxyalkanoate (PHA) and from about 20 to about 100 weight percent polylactic acid (PLA), and, optionally, other biopolymers, other polymers, nucleating agents, chain extenders, fatty amides, and fillers, wherein each of the two sealant film layers may have same or different amounts of PHA, PLA, and other biopolymers, other polymers, nucleating agents, chain extenders, fatty amides, and fillers; and a core film layer comprising a blend of from about 30 to about 80 wt. % polyhydroxalkanoate (PHA), from about 20 to about 40 wt. % polylactic acid (PLA), and, optionally, minor amounts of other biopolymers, other polymers, nucleating agents, chain extenders, fatty amides, and fillers, wherein the core film layer is disposed between the at least two sealant film layers.

In some embodiments, the biaxially-oriented industrial or home compostable film web includes: at least two skin film layers wherein the at least two skin film layers comprise a blend of from about 0 to about 80 wt. % polyhydroxyalkanoate (PHA) and from about 20 to about 100 weight percent polylactic acid (PLA), and, optionally, other biopolymers, other polymers, nucleating agents, chain extenders, fatty amides, and fillers, wherein each of the two sealant film layers may have same or different amounts of PHA, PLA, and other biopolymers, other polymers, nucleating agents, chain extenders, fatty amides, and fillers; and a core film layer comprising a blend of from about 30 to about 80 wt. % polyhydroxalkanoate (PHA), from about 20 to about 40 wt. % polylactic acid (PLA), and, optionally, minor amounts of other biopolymers, other polymers, nucleating agents, chain extenders, fatty amides, and fillers, wherein the core film layer is disposed between the at least two skin film layers.

In some embodiments, the biaxially-oriented industrial or home compostable film web includes: a skin film layer comprising a blend of from about 0 to about 80 wt. % polyhydroxyalkanoate (PHA) and from about 50 to about 70 weight percent polylactic acid (PLA), and, optionally, minor amounts of other biopolymers, other polymers, nucleating agents, chain extenders, fatty amides, and fillers; a core film layer comprising a blend of from about 30 to about 80 wt. % polyhydroxalkanoate (PHA), from about 20 to about 40 wt. % polylactic acid (PLA), and, optionally, minor amounts of minor amounts of other biopolymers, other polymers, nucleating agents, chain extenders, fatty amides, and fillers; and a sealant film layer comprising a blend of from 0 to about 80 wt. % polyhydroxyalkanoate (PHA) and from about 20 to about 100 weight percent polylactic acid (PLA), and, optionally, minor amounts of other biopolymers, other polymers, nucleating agents, chain extenders, fatty amides, and fillers, wherein the core film layer is disposed between the skin film layer and the sealant film layer.

In some embodiments, the PHA of the core film layer includes from about 2 to about 10 mole percent 3-hydroxyhexanoate and the balance 3-hydroxybutyrate.

In some embodiments, the PHA of the sealant film layer includes from about 2 to about 10 mole percent 3-hydroxyhexanoate and the balance 3-hydroxybutyrate.

In some embodiments, the PHA of the skin film layer includes from about 2 to about 10 mole percent 3-hydroxyhexanoate and the balance 3-hydroxybutyrate.

In some embodiments, the biaxially-oriented industrial or home compostable film has an oven shrinkage of from 0 to less than about 5% in the machine direction (MD) and an oven shrinkage of from 0 to less than about 15% in the transverse direction (TD).

In some embodiments, the biaxially-oriented industrial or home compostable film has a pin puncture above about 700 grams-force (gf).

In some embodiments, there is provided a biaxially-oriented industrial or home compostable print film web having a the core film layer disposed between the combination of the skin film layer and the sealant film layer.

In some embodiments, there is provided a biaxially-oriented industrial or home compostable barrier film web having the core film layer disposed between the combination of the skin film layer and the sealant film layer.

In some embodiments, the biaxially-oriented industrial or home compostable print film web has an oven shrinkage of from 0 to less than about 5.0% in the machine direction (MD) and an oven shrinkage of from 0 to less than about 15% in the transverse direction (TD).

In some embodiments, the biaxially-oriented industrial or home compostable print film has a pin puncture range above about 700 grams-force (gf).

In some embodiments, the biaxially-oriented industrial or home compostable print film web has a haze value below 15%.

In some embodiments, there is provided biaxially-oriented industrial or home compostable barrier film web having the core film layer disposed between two of the sealant film layers.

In some embodiments, the biaxially-oriented barrier film has an oven shrinkage of from 0 to less than about 5.0% in the machine direction (MD) and an oven shrinkage of from 0 to less than about 15% in the transverse direction (TD).

In some embodiments, the biaxially-oriented barrier film has a pin puncture range above about 700 grams-force (gf).

In some embodiments, there is provided a biaxially-oriented industrial or home compostable print film web having the core film layer disposed between two of the skin film layers.

In some embodiments, prior to or simultaneous with the annealing step, the biaxially-oriented industrial or home compostable film web is relaxed in the transverse direction (TD) from about 5% to about 25% from stretching in the transverse direction (TD).

In some embodiments, the biaxially-oriented industrial or home compostable film web is annealed at a temperature ranging from about 110° C. to about 130° C. during a biaxial orientation process and prior to or simultaneous with the annealing step, the industrial or home compostable film web is relaxed in the transverse direction (TD) from about 15% to about 25% from stretching in the transverse direction (TD).

In some embodiments, there is provided a biaxially-oriented barrier web that is coated and/or metalized.

As described in more detail below, certain annealing conditions may provide the optimal dimensional stabilities or minimize shrinkage of poly (hydroxyalkanoate)-based films in the MD and TD directions. If annealed properly, the poly (hydroxyalkanoate)-based film should not change in diameter over time, or when exposed to elevated temperatures. Accordingly, embodiments of the disclosure provide conditions which can provide poly (hydroxyalkanoate)-based films biaxial dimensional stability. Dimensionally stable poly (hydroxyalkanoate)-based films made according to the disclosure may be particularly useful for in the food packaging industry.

### BRIEF DESCRIPTION OF THE DRAWINGS

FIG. 1 is a cross-sectional view, not to scale, of a portion of a biaxial-oriented web according to a first embodiment of the disclosure.

FIG. 2 is a cross-sectional view, not to scale, of a portion of a biaxially-oriented web according to a second embodiment of the disclosure.

FIG. 3 is a cross-sectional view, not to scale, of a portion of a biaxially-oriented web according to a third embodiment of the disclosure.

FIG. 4 is a cross-sectional view, not to scale, of a portion of a biaxially-oriented web according to a fourth embodiment of the disclosure.

FIG. 5 is a cross-sectional view, not to scale, of a portion of a biaxially-oriented web according to a fifth embodiment of the disclosure.

FIG. 6 is a cross-sectional view, not to scale, of a portion of a biaxially-oriented web according to a sixth embodiment of the disclosure.

### DETAILED DESCRIPTION

In one aspect, the present disclosure provides polymeric film compositions which are suitable for, among other things, packaging for consumer goods.

Preferably, the polymeric film compositions are biodegradable and/or industrial or home compostable. More particularly the polymeric film compositions are both biodegradable and industrial or home compostable.

As used herein, the term “biodegradable” refers to a plastic or polymeric material that will undergo biodegradation by living organisms (microbes) in anaerobic and aerobic environments (as determined by ASTM D5511), in soil environments (as determined by ASTM 5988), in freshwater environments (as determined by ASTM D5271 (EN 29408)), or in marine environments (as determined by ASTM D6691). The biodegradability of biodegradable plastics can also be determined using ASTM D6868 and European EN 13432.

The polymeric film compositions of the present disclosure are preferably also “compostable”, as determined by ASTM D6400 for industrial or home compostability.

In particular, the biodegradable polymeric film composition includes poly (hydroxyalkanoates) as the biodegradable polymer. The composition is generally made up of from about 5 weight percent to about 95 weight percent poly (hydroxyalkanoates). More preferably, the composition is made up of from about 20 weight percent to about 90 weight percent poly (hydroxyalkanoates). Still more preferably, the polymeric composition includes from about 30 weight percent to about 70 weight percent poly (hydroxyalkanoates)

In some instances, the poly (hydroxyalkanoates) used to make the biodegradable films are preferably made up of a mixture of monomeric units. Accordingly, the poly (hydroxyalkanoates) may include from about 90 to about 99.9 mole percent monomer residues of 3-hydroxybutyrate and from about 0.1 to about 10 mole percent monomer residues of a second 3-hydoxyalkanoate having from 5 to 12 carbon atoms. In one embodiment, a poly (hydroxyalkanoate) containing from about 97 to about 99 mole percent monomer residues of 3-hydroxybutyrate and from about 1 to about 3 mole percent monomer residues of a 3-hydoxyhexanoate may be used to make one or more layers of a composite polymeric film. Another one or more layers of the composite polymeric film may include a poly (hydroxyalkanoate) containing from about 92 to about 96 mole percent monomer residues of 3-hydroxybutyrate and from about 4 to about 10 mole percent monomer residues of a 3-hydoxyhexanoate.

The polymeric composition film may also include a second biodegradable polymer selected from the group consisting of poly (butylene succinate), poly(butylene succinate-co-adipate), poly (lactic acid), cellulose esters (such as cellulose acetate), thermoplastic starch, and mixtures thereof. The amount of this second biodegradable polymer is typically from about 10 weight percent to about 90 weight percent of the total composition.

In some embodiments, the second biodegradable polymer may include poly (butylene succinate) in an amount from about 5 weight percent to about 50 weight percent of the polymeric film composition. More preferably, the polymeric film composition includes from about 10 weight percent to about 30 weight percent poly (butylene succinate).

According to some embodiments, the second biodegradable polymer may include poly (butylene succinate)-co-butylene adipate in an amount from about 5 weight percent to about 50 weight percent of the polymeric film composition. More preferably, the polymeric film composition includes from about 10 weight percent to about 30 weight percent poly (butylene succinate)-co-butylene adipate.

In some instances, the second biodegradable polymer may include poly (lactic acid) in an amount from about 10 weight percent to about 70 weight percent of the polymeric composition. More preferably, the polymeric film composition includes from about 20 weight percent to about 80 weight percent poly (lactic acid).

In certain embodiments, the second biodegradable polymer may include cellulose acetate or another cellulose ester in an amount from about 5 weight percent to about 50 weight percent of the polymeric film composition. More preferably, the polymeric film composition includes from about 10 weight percent to about 30 weight percent cellulose acetate or another cellulose ester.

In general, the poly (hydroxyalkanoate) polymer has a weight average molecular weight from about 50,000 Daltons to about 7.5 million Daltons, and more preferably has a weight average molecular weight from about 300,000 Daltons to about 3.0 million Daltons as determined by ASTM D6474-20.

In certain embodiments, the poly (hydroxyalkanoate) and at least one biodegradable polymer are melt-blended together in a film extrusion process.

In some embodiments, a transesterification reaction is carried out by reacting the poly (hydroxyalkanoate) and at least one biodegradable polymer with each other in a reactive extrusion process.

In some embodiments, a nucleating agent may be present in the polymeric film composition in an amount from about from about 0.1 weight percent to about 5 weight percent. In certain embodiments, the core layer nucleating agent is preferably selected from the group consisting of erythritols, pentaerythritol, dipentaerythritols, artificial sweeteners, stearates, polysaccharides, sorbitols, mannitols, inositols, polyester waxes, nanoclays, behenamide, erucamide, stearamide, oleamide, polyhydroxybutyrate, thymine, cyanuric acid, cytosine, adenine, uracil, guanine, boron nitride and mixtures thereof.

The polymeric film composition may also include an optional plasticizer material as well. Suitable materials for the plasticizer are typically selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol as determined by ASTM D6474-20, poly (ethylene glycols) having a number average molecular weight of 400-10,000 g/mol as determined by ASTM D6474-20, esters of vegetable oils, long chain alkyl acids, adipates, glycerol, isosorbide derivatives or mixtures thereof, polymeric plasticizers, poly (hydroxyalkanoates) copolymers comprising at least 18 mole percent monomer residues of hydroxyalkanoates other than hydroxybutyrate, and mixtures thereof.

The amount of plasticizer in polymeric film composition may be up to about 15 weight percent. More preferably, the polymeric composition is made up of from about 1 weight percent to about 8 weight percent of the plasticizer.

Optionally, the polymeric film composition may also include a filler material. Suitable materials for the filler are typically selected from the group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, casein, collagen, gelatin, polysaccharides, guar gum, xanthan gum, succinoglycan, natural rubbers; rosinic acid, lignins, natural fibers, jute, kenaf, hemp, ground nut shells, wood flour, and mixtures thereof.

The amount of filler in the polymeric film composition may be up to about 50 weight percent. More preferably, the core layer polymeric film composition is made up of from about 5 weight percent to about 30 weight percent of the filler.

Moreover, in some instances, the polymeric film composition may include up to 50 weight percent of one or more additives selected from the group consisting of poly (vinyl alcohols), poly (vinyl acetate), poly(vinyl laurate), poly(ethylene vinyl acetate), poly (glycolic acid), furandicarboxylic acid-based polyesters, cellulose, nanocellulose, glucans, and mixtures thereof.

In general, the at least one poly (hydroxyalkanoate) polymer has a weight average molecular weight from about 50,000 Daltons to about 7.5 million Daltons, and more preferably has a weight average molecular weight from about 300,000 Daltons to about 3.0 million Daltons as determined by ASTM D6474-20.

In a further aspect, the present disclosure also provides a product package for a consumer goods product, which makes use of the aforementioned polymeric composition. Specifically, the product package includes at least one biodegradable package portion which comprises the aforementioned polymeric composition. The product package may be used for the packaging of clothing, household goods, foods, and health and beauty products.

In certain embodiments, this biodegradable package may be formed by a co-extrusion method. The package may be made by co-extruding at least three layers selected from a skin film layer, a sealant film layer, and a combination of a sealant film layer and a skin film layer, wherein each of the sealant film layer and the skin film layer includes a blend of from 0 to about 80 wt. % polyhydroxyalkanoate (PHA) and from about 20 to about 100 weight percent polylactic acid (PLA), and, optionally, minor amounts of other biopolymers, other polymers, nucleating agents, chain extenders, fatty amides, and fillers; and a core film layer containing a blend of from about 30 to about 80 wt. % polyhydroxalkanoate (PHA), from about 20 to about 40 wt. % polylactic acid (PLA), and, optionally, minor amounts of other biopolymers, other polymers, nucleating agents, chain extenders, fatty amides, and fillers. The core film layer is disposed between a combination of the skin film layer and the sealant film layer, is disposed between two sealant film layers, or is disposed between two skin film layers, wherein each of the sealant film layer and the skin film layer contains the same or different amounts of PHA, PLA, and other biopolymers, other polymers, nucleating agents, chain extenders, fatty amides, and fillers.

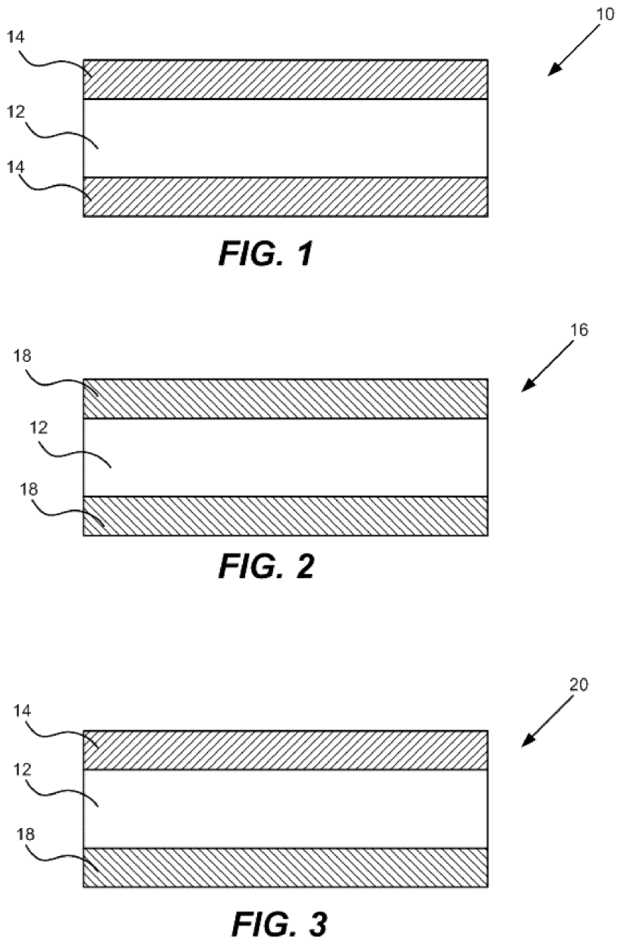

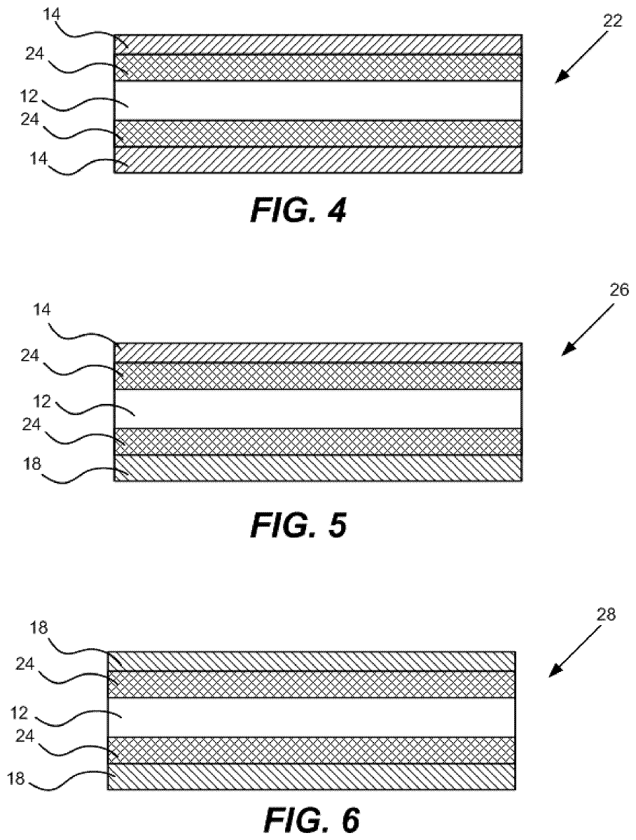

For example, with reference to FIG. 1, a barrier film 10 may contain one or more core layers 12 between two sealant layers 14 wherein each of the sealant layers 14 may contain one or more sealant layers 14. With reference to FIG. 2, a print film 16 may contain one or more core layers 12 between two skin 18 layers wherein each of the skin layers 18 may contain one or more skin layers 18. A print film or barrier film 20, as shown in FIG. 3, may also be made with a core layer or layers 12, a skin layer 18 containing one or more skin layers 18 and a sealant layer 14 containing one or more sealant layers 14. Other variations of composite biaxial-oriented films are illustrated in FIGS. 4-6. In each of the FIGS. 4-6, the layer or layers 24 can be any combination of one or more skin layers, barrier layers, other biodegradable layers, metalization layers, coatings, and the like. The core layer(s) 12, sealant layer(s) 14, and skin layer(s) 18 are as described above. The structures illustrated in FIGS. 1 and 4 may be heat sealable barrier film structures. The structures illustrated in FIGS. 2 and 6 may be print film structures, while the structures illustrated in FIGS. 3 and 5 may be either print film structures or barrier film structures.

### Crystallinity

The volume percent crystallinity (Pc) of a semi-crystalline polymer (or copolymer) often determines what type of end-use properties the polymer possesses. For example, highly (greater than 50%) crystalline polyethylene polymers are strong and stiff, and suitable for products such as plastic milk containers. Low crystalline polyethylene, on the other hand, is flexible and tough, and is suitable for products such as food wraps and garbage bags. Crystallinity can be determined in a number of ways, including x-ray diffraction, differential scanning calorimetry (DSC), density measurements, and infrared absorption. The most suitable method depends upon the material being tested.

The volume percent crystallinity (c) of the poly (hydroxyalkanoate) copolymer may vary depending on the mol percentage of poly (3-hydroxyhexanoate) in the poly (hydroxyalkanoate) copolymer. The addition of poly (3-hydroxyhexanoate) effectively lowers the volume percent crystallinity of the poly (hydroxyalkanoate) copolymer, crystallization rate, and melting temperature while providing an increase in the flexibility of the copolymer. Nucleating agents, as described herein may be used to speed up the crystallization process of the poly (hydroxyalkanoate) copolymers.

In general, poly (hydroxyalkanoates) of the described herein for use in the making the composite film structures preferably have a crystallinity of from about 0.1% to about 99% as measured via x-ray diffraction; more preferably from about 2% to about 80%; more preferably still from about 20% to about 70%.

When a poly (hydroxyalkanoates) of the present invention is to be processed into a molded article or film, the amount of crystallinity in such poly (hydroxyalkanoate) is more preferably from about 10% to about 80% as measured via x-ray diffraction; more preferably from about 20% to about 70%; more preferably still from about 30% to about 60%.

### Melt Temperature

Preferably, the biodegradable poly (hydroxyalkanoates) of the present invention have a melt temperature (Tm) of from about 30° C. to about 170° C., more preferably from about 90° C. to about 165° C., more preferably still from about 130° C. to about 160° C.

### Method of Film Manufacture

The biaxially-oriented industrial or home compostable films disclosed herein have increased biodegradability and/or compostability and may be processed using conventional procedures for producing single or multilayer films on conventional film-making equipment. Pellets of the poly (hydroxyalkanoates) of the present invention may be dry blended and then melt mixed in a film extruder. Alternatively, if insufficient mixing occurs in the film extruder, the pellets may be dry blended and then melt mixed in a pre-compounding extruder followed by repelletization prior to film extrusion. Co-extrusion of the skin film layer(s) or sealant film layer(s) with the core film layer(s) is a particularly suitable process for making the barrier webs and print webs described herein.

The poly (hydroxyalkanoates) may be melt processed into a film using a cast film extrusion method. In a cast film process, the molten polymer mixture is extruded through slot die. Generally, the flat web from the slot die is cooled on a large moving polished metal roll. The web quickly cools, and peels off this first roll, passes over one or more auxiliary cooling rolls, then through a set of rubber-coated pull or “haul-off” rolls, and finally to a winder.

For the production of multilayer films, co-extrusion processes are preferably employed. Such processes require more than one extruder and either a co-extrusion feed-block or multi-manifold die system or combination of the two to achieve the multilayer film structure.

It has been discovered, quite surprisingly, that the annealing temperatures in the TD oven during biaxial orientation of the cast film production process may contribute to or minimize shrinkage of poly (hydroxyalkanoate)-based polymer films. The improved annealing process of a poly (hydroxyalkanoate)-based polymer film may be achieved by heating the film to a temperature ranging from about 110° C. to about 135° C., preferably from about 125° C. to about 130° C. during a biaxial orientation process, then relaxing the film from stretching in the transverse direction (TD) from about 5% to about 25%. In some embodiments, the film is first relaxed in the transverse direction (TC) from about 15% to about 25% then annealed at a temperature ranging from about 110° C. to about 120° C. during a biaxial orientation step. It is believed that annealing the semi-crystalline film material at a relatively a high temperature can improve quality of the film in terms of micro and macro-structural features such as crystalline morphology, density, grain size etc. The overall shrinkage improvement of the film depends on the annealing temperature, the annealing time, the biaxial orientation temperature and the amount of relaxing of the film after the annealing step.

The following non-limiting example illustrates a process to control shrinkage of poly (hydroxyalkanoate)-based polymeric blown films.

### Example 1

Formulated poly (hydroxyalkanoate)-based polymeric materials were converted into barrier and print film by using a co-extrusion process for extruding three or more layers simultaneously. Experiments were carried out with various annealing roller temperatures with the same extruder. Film samples were prepared with the annealing roller temperature at 60° C., 80° C., 100° C., 110° C. and 120° C. Both machine direction (MD) and transverse direction (TD) shrinkage was investigated using the method described in ASTM D2732. The films annealing temperatures and shrinkage data in Table 2. The shrinkage measurement temperatures were selected based on a storage temperature of 45° C. for finished products storage and shipping and post processing temperatures, such as coating, metallization and sealing temperatures (80° C., 100° C. and 110°.

TABLE 1

| Annealing | Shrinkage | | | |
|---|---|---|---|---|
| Roller | Measurement | | MD | TD |
| Temperature | Temperature | Time in oil | Shrinkage | Shrinkage |
| (° C.) | (° C.) | bath (sec) | (%) | (%) |
| 60 | 45 | 30 | 4 | 0 |
| 60 | 80 | 30 | 33 | −1.3 |
| 60 | 100 | 30 | 43 | −1.7 |
| 60 | 110 | 30 | 49.3 | −2 |
| 80 | 45 | 30 | 2 | 0 |
| 80 | 80 | 30 | 26.7 | −3.7 |
| 80 | 100 | 30 | 37.7 | −4.2 |
| 80 | 110 | 30 | 44.8 | −4.5 |
| 100 | 45 | 30 | 1.7 | 0 |
| 100 | 80 | 30 | 14.7 | −3 |
| 100 | 100 | 30 | 25.7 | −4.2 |
| 100 | 110 | 30 | 32.7 | −5 |
| 110 | 45 | 30 | 0.8 | 0 |
| 110 | 80 | 30 | 6.7 | −1 |
| 110 | 100 | 30 | 13 | −2.3 |
| 110 | 110 | 30 | 18 | −2.7 |
| 120 | 45 | 30 | 0 | 0 |
| 120 | 80 | 30 | 1.8 | −0.2 |
| 120 | 100 | 30 | 4 | −1 |
| 120 | 110 | 30 | 6 | −1 |

As shown in the above table, the poly (hydroxyalkanoate) film shrinkage values with lower annealing temperature (60° C.) were very high compared to the industry standard of less than 5%. The shrinkage values significantly decreased with annealing temperatures above 100° C. and reached the industrial standard values of less than 5% with an annealing temperature of 120° C.

The following non-limiting example illustrates a process to control shrinkage of poly (hydroxyalkanoate)-based polymeric films made by a biaxially-oriented film process.

### Example 2

Samples poly (hydroxyalkanoate)-based films were prepared using various transverse-direction orientation (TDO) annealing temperatures using the same extruder and MDO profile. The transverse direction (TD) annealing temperatures that were used were 60° C., 93° C., and 129° C. The shrinkage measurement temperatures were selected based on the maximum temperature expected for finished products storage/shipping (45° C.) and post processing process; like coating, metallization, and sealing temperatures (80° C., 100° C. and 110° C.). Both machine direction (MD) and transverse direction (TD) shrinkage were investigated by heating the finished film in a 110° C. oven for 10 minutes. The results are provided in the following table.

TABLE 2

| Annealing | Oven Shrinkage | | MD | TD |
|---|---|---|---|---|
| Temperature | Temperature | Oven Time | Shrinkage | Shrinkage |
| (° C.) | (° C.) | (minutes) | (%) | (%) |
| 60 | 110 | 10 | 14 | 39 |
| 93 | 110 | 10 | 6 | 22 |
| 129 | 110 | 10 | 0 | 0 |

The poly (hydroxyalkanoate) film shrinkage values at the lower annealing temperature (60° C.) were very high compared to the industry standard of less than 5%. The shrinkage values were significantly decreased with higher annealing temperatures and reached the industrial standard values of less than 5% with an annealing temperature of 129° C.

Poly (hydroxyalkanoate)-based polymeric films were made by modifying poly (hydroxyalkanoates) with melt strength enhancers, chain extenders, and other processing aids. The poly (hydroxyalkanoate)-based films made according to the disclosure may contain from about 50 to 80 weight percent of poly (hydroxyalkanoate) copolymer and from about 20 to about 50 wt. % polymer modifiers. In some embodiments, the poly (hydroxyalkanoate) copolymer is poly-3-hydroxybutyrate-co-3-hydroxyhexanoate.

Exemplary formulations that may be used to make co-extruded biaxially-oriented biodegradable films according to the disclosure. The major components of the core films, sealant films and skin films are set in the following Table 3.

TABLE 3
Film Formulations

| | | Sealant 1 | Sealant 2 | Core 1 | Core 2 | Core 3 | Skin 1 | Skin 2 |
|---|---|---|---|---|---|---|---|---|
| Material | Product | Wt. % | Wt. % | Wt. % | Wt. % | Wt. % | Wt. % | Wt. % |
| PHA 1 | 2 mol % | 40-60 | 0 | 0 | 0 | 0 | 40-60 | 0 |
| | Hexanoate | | | | | | | |
| | in polymer | | | | | | | |
| PHA 2 | 6 mol % | 0 | 40-60 | 60-80 | 40-60 | 60-80- | 0 | 40-60 |
| | Hexanoate | | | | | | | |
| | in polymer | | | | | | | |
| PLA 1 | Ingeo 2003D | 0 | 0 | 20-40 | 0 | 20-40 | 40-60 | 40-60 |
| PLA 2 | Ingeo 4060D | 40-60 | 40-60 | 0 | 20-30 | 0 | 0 | 0 |
| Chain | 2,5-dimethyl- | 0 | 0 | 0 | 0 | 0-0.1 | 0 | 0 |
| Extender | 2,5-di(tert- | | | | | | | |
| | butylperoxy)hexane | | | | | | | |
| Filler | Omya 55-OM | 0 | 0 | 0 | 15-25 | 0 | 0 | 0 |
| | (TP92703) | | | | | | | |
| Nucleating | Pentaerythritol | 0-1 | 0-1 | 0-1 | 0-1 | 0-1 | 0-1 | 0-1 |
| agent | | | | | | | | |
| Plasticizer | PEG 8000 | 0 | 0 | 0-8 | 0-8 | 0-8 | 0 | 0 |

In the following tables, various biaxial annealing temperatures, and relaxation percentages were used to determine the shrinkage rates in the MD and TD directions using the same oven shrinking temperatures. The pin puncture force was determined according to ASTM D-4833. The haze values were determined according to ASTM D1003.

TABLE 4
Barrier Film Results

| | | | | TDO | | Oven | Oven | |
|---|---|---|---|---|---|---|---|---|
| | | | | Anneal | TD | Shrink | Shrink | Pin |
| | | | | Temp. | Relax | (120° C., | (120° C., | Puncture |
| Run | Sealant | Core | Sealant | (° C.) | (%) | MD) | TD) | (gf) |
| 1 | Sealant 1 | Core 1 | Sealant 1 | 130 | 10 | 1.0 | 8.3 | 1074 |
| 2 | Sealant 1 | Core 1 | Sealant 1 | 128 | 10 | 1.7 | 10.7 | 1097 |
| 3 | Sealant 1 | Core 1 | Sealant 1 | 128 | 6.98 | 2.3 | 15.0 | N/A |
| 4 | Sealant 1 | Core 1 | Sealant 1 | 125 | 11.76 | 2.3 | 12.3 | N/A |
| 5 | Sealant 1 | Core 1 | Sealant 1 | 74 | 10 | 11.5 | 55.3 | 1113 |
| 6 | Sealant 1 | Core 3 | Sealant 1 | 125 | 11.76 | 2 | 7.2 | N/A |
| 7 | Sealant 1 | Core 3 | Sealant 1 | 125 | 8.7 | 2.3 | 18.2 | N/A |
| 8 | Sealant 1 | Core 3 | Sealant 1 | 74 | 10 | 9.8 | 48.5 | 1117 |
| 9 | Sealant 1 | Core 3 | Sealant 1 | 60 | 10 | 26.0 | 56.0 | N/A |

TABLE 5
Print Film Results

| | | | | TDO | | Oven | Oven | | |
|---|---|---|---|---|---|---|---|---|---|
| | | | | Anneal | TD | Shrink | Shrink | | Pin |
| | | | | Temp. | Relax | (120° C., | (120° C., | Haze | Puncture |
| Run | Skin | Core | Skin | (° C.) | (%) | MD) | TD) | % | (gf) |
| 1 | Skin 1 | Core 1 | Skin 1 | 128 | 10 | 1.5 | 12.3 | 20.9 | 806 |
| 2 | Skin 1 | Core 1 | Skin 1 | 60 | 10 | 11.7 | 43.3 | 16.5 | 1558 |
| 3 | Skin 1 | Core 3 | Skin 1 | 129 | 15 | 3 | 6 | 15 | N/A |
| 6 | Skin 1 | Core 3 | Skin 1 | 93 | 15 | 22 | 44 | 25 | N/A |
| 7 | Skin 1 | Core 3 | Skin 1 | 60 | 15 | 28 | 56 | 23 | N/A |
| 9 | Skin 1 | Core 1 | Skin 1 | 113 | 15 | 4.5 | 17.3 | 13.2 | 1128 |
| 10 | Skin 1 | Core 1 | Skin 1 | 113 | 20 | 5.2 | 12.5 | 14.7 | 1149 |
| 10 | Skin 1 | Core 1 | Skin 1 | 113 | 25 | 4.5 | 8.2 | 20.7 | 1225 |

Table 6 provides an illustration of print films made according to the disclosure that have relatively low haze values.

TABLE 6

| | | | | TDO | | Oven | Oven | | |
|---|---|---|---|---|---|---|---|---|---|
| | | | | Anneal | TD | Shrink | Shrink | | Pin |
| | | | | Temp. | Relax | (120° C., | (120° C., | Haze | Puncture |
| Run | Skin | Core | Skin | (° C.) | (%) | MD) | TD) | % | (gf) |
| 1 | Skin 1 | Core 1 | Skin 1 | 113 | 20 | 5.2 | 12.5 | 14.7 | 1149 |
| 2 | Skin 1 | Core 1 | Skin 1 | 113 | 15 | 4.5 | 17.3 | 13.2 | 1128 |
| 3 | Skin 1 | Core 1 | Skin 1 | 128 | 10 | 1.7 | 11 | 12.2 | 702 |
| 4 | Skin 1 | Core 3 | Skin 1 | 128 | 5 | 3.2 | 16 | 14 | N/A |
| 5 | Skin 1 | Core 3 | Skin 1 | 120 | 8.7 | 2.7 | 22 | 10 | N/A |

The foregoing examples for composite biaxially-oriented biodegradable films illustrate that at annealing temperatures from about 110° C. to about 130° C. and TD relax rates ranging from 5 to 25% from stretching in the TD direction can produce biaxially-oriented biodegradable films having shrinkage rates of from about 1 to less than 5% in the machine direction and from about 6 to less than 15% in the transverse direction.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A biaxially-oriented industrial or home compostable film web comprising at least 3 co-extruded layers selected from the group consisting of:
a skin film layer, a sealant film layer, and a combination of a sealant film layer and a skin film layer, wherein each of the sealant film layer and the skin film layer comprises a blend of from 0 to about 80 wt. % polyhydroxyalkanoate (PHA) and from about 20 to about 100 weight percent polylactic acid (PLA), and, optionally, minor amounts of other biopolymers, other polymers, nucleating agents, chain extenders, fatty amides, and fillers; and
a core film layer comprising a blend of from about 30 to about 80 wt. % polyhydroxalkanoate (PHA), from about 20 to about 40 wt. % polylactic acid (PLA), and, optionally, minor amounts of other biopolymers, other polymers, nucleating agents, chain extenders, fatty amides, and fillers, wherein the core film layer is disposed between a combination of the skin film layer and the sealant film layer, is disposed between two sealant film layers, or is disposed between two skin film layers, wherein each of the sealant film layer and the skin film layer comprises the same or different amounts of PHA, PLA, and other biopolymers, other polymers, nucleating agents, chain extenders, fatty amides, and fillers, and wherein the PHA of the core film layer, the sealant film layer, and the skin film layer comprise from about 2 to about 10 mole percent 3-hydroxyhexanoate and the balance 3-hydroxybutyrate.

2-4. (canceled)

5. The biaxially-oriented industrial or home compostable film web of claim 1, wherein the biaxially-oriented industrial or home compostable film has an oven shrinkage of from 0 to less than about 5% in the machine direction (MD) and an oven shrinkage of from 0 to less than about 15% in the transverse direction (TD).

6. The biaxially-oriented industrial or home compostable film web of claim 1, wherein the biaxially-oriented industrial or home compostable film has a pin puncture above about 700 grams-force (gf).

7. A biaxially-oriented industrial or home compostable print film web comprising the core film layer disposed between the combination of the skin film layer and the sealant film layer of claim 1.

8. A biaxially-oriented industrial or home compostable barrier film web comprising the core film layer disposed between the combination of the skin film layer and the sealant film layer of claim 1.

9. The biaxially-oriented industrial or home compostable print film web of claim 8, wherein the print film web has an oven shrinkage of from 0 to less than about 5.0% in the machine direction (MD) and an oven shrinkage of from 0 to less than about 15% in the transverse direction (TD).

10. The biaxially-oriented industrial or home compostable print film web of claim 8, wherein the biaxially-oriented industrial or home compostable print film web has a pin puncture range above about 700 grams-force (gf).

11. The biaxially-oriented industrial or home compostable print film web of claim 8, wherein the biaxially-oriented industrial or home compostable print film has a haze value below 15%.

12. A biaxially-oriented industrial or home compostable barrier film web comprising the core film layer disposed between two of the sealant film layers of claim 1.

13. The biaxially-oriented industrial or home compostable barrier film web of claim 12, wherein the biaxially-oriented barrier film has an oven shrinkage of from 0 to less than about 5.0% in the machine direction (MD) and an oven shrinkage of from 0 to less than about 15% in the transverse direction (TD).

14. The biaxially-oriented industrial or home compostable barrier film web of claim 12, wherein the biaxially-oriented barrier film has a pin puncture range above about 700 grams-force (gf).

15. A biaxially-oriented industrial or home compostable print film web comprising the core film layer disposed between two of the skin film layers of claim 1.

16. A method for improving the dimensional stability of a biaxially-oriented industrial or home compostable film web comprising at least three co-extruded layers, comprising extruding a composite poly (hydroxyalkanoate)-based polymer film; and annealing the composite poly (hydroxyalkanoate) polymer film at a temperature ranging from about 110° C. to about 130° C. during a biaxial orientation process.

17. The method of claim 16, wherein, prior to or simultaneous with the annealing step, the biaxially-oriented industrial or home compostable film web is relaxed in the transverse direction (TD) from about 5% to about 25% from stretching in the transverse direction (TD).

18. The method of claim 16, wherein the biaxially-oriented industrial or home compostable film web is annealed at a temperature ranging from about 110° C. to about 130° C. during a biaxial orientation process and prior to or simultaneous with the annealing step, the industrial or home compostable film web is relaxed in the transverse direction (TD) from about 15% to about 25% from stretching in the transverse direction (TD).

19. The method of claim 16, wherein the biaxially-oriented industrial or home compostable film web comprises:
at least two sealant film layers wherein the at least two sealant film layers comprise a blend of from about 0 to about 80 wt. % polyhydroxyalkanoate (PHA) and from about 20 to about 100 weight percent polylactic acid (PLA), and, optionally, other biopolymers, other polymers, nucleating agents, chain extenders, fatty amides, and fillers, wherein each of the two sealant film layers may have same or different amounts of PHA, PLA, and other biopolymers, other polymers, nucleating agents, chain extenders, fatty amides, and fillers; and
a core film layer comprising a blend of from about 30 to about 80 wt. % polyhydroxalkanoate (PHA), from about 20 to about 40 wt. % polylactic acid (PLA), and, optionally, minor amounts of other biopolymers, other polymers, nucleating agents, chain extenders, fatty amides, and fillers, wherein the core film layer is disposed between the at least two sealant film layers, and wherein the PHA of the core film layer and the at least two sealant film layers, comprise from about 2 to about 10 mole percent 3-hydroxyhexanoate and the balance 3-hydroxybutyrate.

20. A biaxially-oriented barrier web made by the method of claim 19, further comprising coating and/or metallizing the barrier web.

21. The method of claim 16, wherein the biaxially-oriented industrial or home compostable film web comprises:
at least two skin film layers wherein the at least two skin film layers comprise a blend of from about 0 to about 80 wt. % polyhydroxyalkanoate (PHA) and from about 20 to about 100 weight percent polylactic acid (PLA), and, optionally, other biopolymers, other polymers, nucleating agents, chain extenders, fatty amides, and fillers, wherein each of the two sealant film layers may have same or different amounts of PHA, PLA, and other biopolymers, other polymers, nucleating agents, chain extenders, fatty amides, and fillers; and
a core film layer comprising a blend of from about 30 to about 80 wt. % polyhydroxalkanoate (PHA), from about 20 to about 40 wt. % polylactic acid (PLA), and, optionally, minor amounts of other biopolymers, other polymers, nucleating agents, chain extenders, fatty amides, and fillers, wherein the core film layer is disposed between the at least two skin film layers.

22. A biaxially-oriented print web made by the method of claim 21, further comprising printing on the print web.

23. The method of claim 16, wherein the biaxially-oriented industrial or home compostable film web comprises:
a skin film layer comprising a blend of from about 0 to about 80 wt. % polyhydroxyalkanoate (PHA) and from about 50 to about 70 weight percent polylactic acid (PLA), and, optionally, minor amounts of other biopolymers, other polymers, nucleating agents, chain extenders, fatty amides, and fillers;
a core film layer comprising a blend of from about 30 to about 80 wt. % polyhydroxalkanoate (PHA), from about 20 to about 40 wt. % polylactic acid (PLA), and, optionally, minor amounts of minor amounts of other biopolymers, other polymers, nucleating agents, chain extenders, fatty amides, and fillers; and
a sealant film layer comprising a blend of from 0 to about 80 wt. % polyhydroxyalkanoate (PHA) and from about 20 to about 100 weight percent polylactic acid (PLA), and, optionally, minor amounts of other biopolymers, other polymers, nucleating agents, chain extenders, fatty amides, and fillers, wherein the core film layer is disposed between the skin film layer and the sealant film layer.

24. The method of claim 16, wherein the biaxially-oriented industrial or home compostable film web has a haze value of less than about 15%.

25. The method of claim 16, wherein the biaxially-oriented industrial or home compostable film web comprising at least 3 co-extruded layers has an oven shrinkage of from 0 to less than about 5% in the machine direction (MD) at 120° C. and an oven shrinkage of from 0 to less than about 15% in the transverse direction (TD).

26. The method of claim 16, wherein the biaxially-oriented industrial or home compostable film web has a pin puncture range of about 700 grams-force (gf).

27. A biaxially-oriented industrial or home compostable film web made by the method of claim 16.

28. A biaxially-oriented industrial or home compostable film web comprising at least three co-extruded layers made by the method of claim 16.
